(19) United States
(12) Patent Application Publication
(10) Pub. No.: US 2004/0026958 A1
(43) Pub. Date: Feb. 12, 2004

(54) Expandable enclosure for a recreational vehicle

(76) Inventor: Jeff Condino, Plano, TX (US)

Correspondence Address: Gardere Wynne Sewell LLP, Suite 3000, 1601 Elm Street, Dallas, TX, 75201-4761, US

(21) Appl. No.: 10/217,819

(22) Filed: Aug. 12, 2002

(51) Int. Cl. B60P 3/34

(52) U.S. Cl. 296/156

(57) ABSTRACT

A system for providing an externally expandable enclosure in a recreational vehicle is disclosed. The expandable enclosure is operatively associated with an aperture formed in wall of the recreational vehicle, providing access to the enclosure from inside the vehicle. The enclosure includes a cover, having a plurality of sidewalls and a face wall, hinged in relation to the aperture such that the cover, when in a closed position, seals the aperture. The enclosure also includes an assembly, coupled to the cover, that is adapted to collapse and stow between the cover and the exterior surface of the recreational vehicle when the cover is closed, and provides an enclosed space accessible through the aperture when the cover is opened.

### FIELD OF THE INVENTION

The present invention relates, generally, to recreational vehicles and, more specifically, to expandable enclosures for recreational vehicles.

### BACKGROUND OF THE INVENTION

Recreational vehicles such as trailers, motor homes and campers generally include beds for providing sleeping accommodations to the users. In order to conserve space in the recreational vehicle, the beds are often either foldable onto an interior wall or otherwise stowable in the recreational vehicle. In some recreational vehicles, in order to maximize use of space, the recreational vehicle may also include a movable external surface, such as a portion of the roof that may be raised to provide more headroom when the recreation vehicle is stationary. A common example of such an expandable surface is a “pop-top” roof on conversion vans, which includes a shell type roof and accordion-like fabric walls.

Although pop-top roofs provide additional space, there is often a desire for still more efficient use of space. To this end it would be desirable to have expandable enclosures on the sides of the recreational vehicle. However, because a cover on an expandable side enclosure is typically vertical when closed, and may be near the ground, expandable side enclosures present weatherproofing problems not encountered with pop-top roofs. In particular, with an expandable enclosure on the side, water (e.g., rain) running down the external wall of the recreational vehicle, or splashing up from the road, is more likely to find its way into the recreational vehicle than with a horizontal cover on a pop-top roof.

### SUMMARY OF THE INVENTION

Accordingly, there is a need for an expandable enclosure on the side of a recreational vehicle that overcomes the foregoing disadvantages.

In particular, there is a need for an expandable side enclosure for a recreational vehicle that has a collapsible structure adaptable between a compacted stowage condition and an expanded open condition providing additional space.

Comprehending that, the present invention provides, in one embodiment, an expandable enclosure assembly, comprising a movable cover having a hinge attachment to the sidewall of a recreational vehicle. The movable cover closes over an aperture in the sidewall, which serves as an entrance to the expandable enclosure. The movable cover opens out and away from the sidewall, between an approximately vertical closed position and an approximately horizontal open position, forming a floor panel for the expandable enclosure. A collapsible tent assembly having an outer face panel, a top panel, and two side panels is secured to the aperture and the movable cover such that opening the movable cover also opens the tent assembly. A collapsible support assembly stretches or forms the tent assembly to its fully open shape and provides stabilization and support to the tent assembly.

In another embodiment of the present invention, a recreational vehicle having a sidewall is provided with an expandable enclosure assembly. The enclosure assembly comprises a movable cover having a face wall, a top edge wall, a bottom edge wall and two side edge walls. The top edge wall includes a hinge connected to the sidewall of the recreational vehicle such that the cover is swingable between an approximately vertical closed position and an approximately horizontal open position. Each of the cover's side edge walls includes a hinge connected between the inside of the cover and enclosure side walls such that the enclosure side walls are swingable downwardly between a closed position, generally parallel with the plane of the cover's face wall, and an open, generally vertical position. The cover's face wall includes a generally horizontal hinge at an upper portion thereof, connected between an inside portion of the cover's bottom edge wall and an enclosure face wall, such that the enclosure face wall is swingable between a closed position, generally parallel to the plane of the cover's face wall, and an open position generally perpendicular to the plane of the cover's face wall. The enclosure assembly further comprises a support wall that includes a generally horizontal hinge, connected to the sidewall of the recreational vehicle such that the platform is swingable between a closed position, generally parallel to the sidewall of the recreational vehicle, and an open, generally horizontal position.

In one embodiment of the present invention, the movable cover further comprises a support member for holding the cover in an open position. Optionally, the support member may provide a locking mechanism to secure the support in a desired position. In another embodiment of the invention, the enclosure further comprises a pair of support members for holding the support platform in an open position. In yet another embodiment of the invention, the support members are flexible cables.

### BRIEF DESCRIPTION OF THE DRAWINGS

FIG. 1 is a perspective view of an expandable enclosure according to the present invention, with the cover in the closed position against the sidewall of a recreational vehicle.

FIG. 2 is a perspective view of an expandable enclosure according to the present invention, with the cover in the open position.

FIG. 3 is a perspective view of an expandable enclosure according to the present invention, with the cover in the open position and the left enclosure side wall opened to the expanded condition.

FIG. 4 is a perspective view of an expandable enclosure according to the present invention, with the cover in the open position and both the left and right enclosure side walls opened.

FIG. 5 is a perspective view of an expandable enclosure according to the present invention with the cover in the open position, both the left and right enclosure side walls opened to the expanded condition and the enclosure face wall swung down.

FIG. 6 is a perspective view of an expandable enclosure according to the present invention with the cover in the open position and the bottom support wall swung down to the expanded position, with the left and right enclosure side walls and enclosure face wall not shown for clarity.

FIG. 7 is a front view of an expandable enclosure according to the present invention in the fully collapsed position.

FIG. 8 is a cross-sectional view of an expandable enclosure according to the present invention in the collapsed position, taken along the line A-A of FIG. 7.

FIG. 9 is a detailed cross-sectional view of an expandable enclosure according to the present invention in the closed position, showing a portion of the expandable enclosure as depicted in FIG. 8.

FIG. 10 is a detailed cross-sectional view of an expandable enclosure according to the present invention in the closed position, showing a portion of the expandable enclosure as depicted in FIG. 8.

FIG. 11 is a front view of an expandable enclosure according to the present invention in the expanded position.

FIG. 12 is a detailed cross-sectional view of an expandable enclosure according to the present invention in the expanded position, taken along the line B-B of FIG. 11.

FIG. 13 is a front view of an expandable enclosure according to the present invention in the closed position.

FIG. 14 is a perspective view of an expandable enclosure according to the present invention in a partially expanded position.

FIG. 15 is a perspective view of an expandable enclosure according to the present invention in an expanded position.

FIG. 16 is a perspective view of an embodiment of a support assembly for an expandable enclosure according to the present invention.

### DETAILED DESCRIPTION OF THE INVENTION

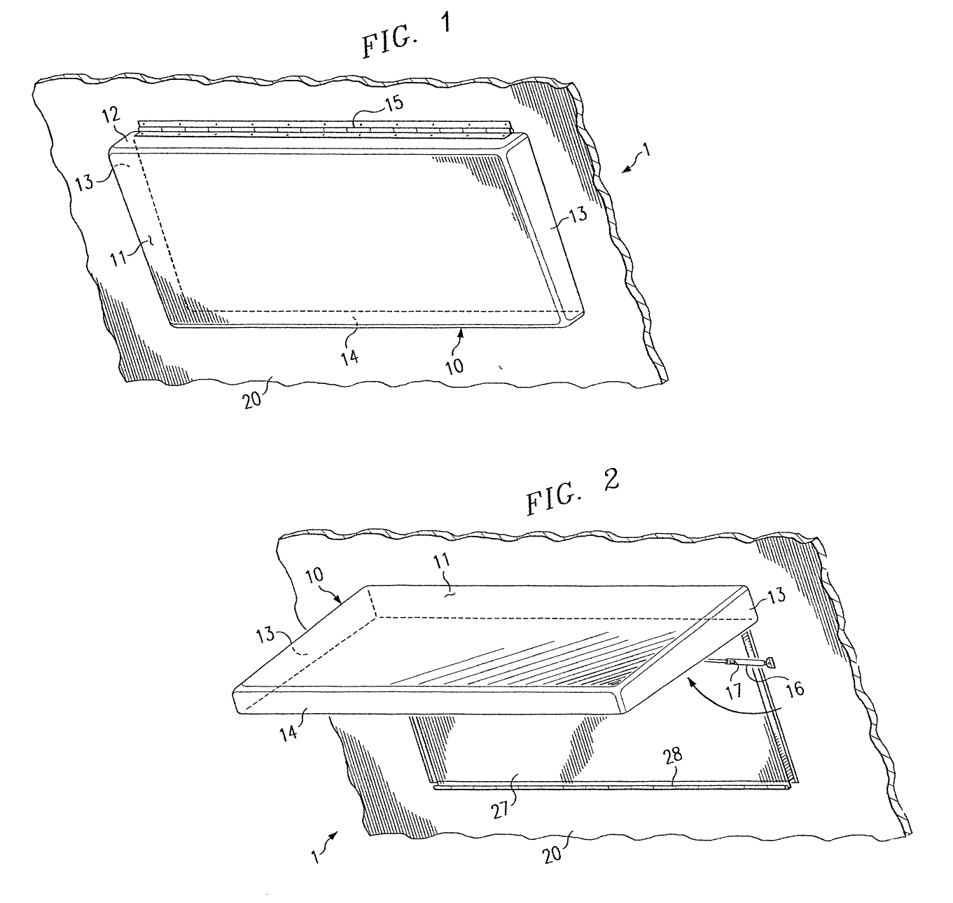

In one embodiment of the present invention, an expandable enclosure is provided by a plurality of rigid members configured to provide a collapsible, solid-walled room. Depending upon the intended use and desired aesthetics, the enclosure may be formed in a number of shapes and form factors. Referring now to FIG. 1, one embodiment of the present invention is illustrated. Expandable enclosure assembly 1 having movable cover 10 attached to the side 20 of a recreational vehicle (not shown) is depicted. Side 20 has an aperture (not shown) formed therein that allows a user access to the enclosure from inside the vehicle once assembly 1 is fully deployed. Cover 10 is shaped somewhat in the nature of a shallow box, with a face wall 11, a top edge wall 12, side edge walls 13 and a bottom edge wall 14. Cover 10 may be fabricated from mold-injected plastic, such as ABS, PVC or HDPE, for example. Cover 10 may also be fabricated from aluminum, carbon fiber, fiberglass, or a foam core laminate material. Foam core laminate or other insulated materials may be used to maintain a comfortable temperature within the expandable enclosure assembly 1 for an occupant. Preferably, cover 10 has relatively large dimensions consistent with use of the expanded space for a foldable bed, i.e., approximately six feet or greater in its longer dimension and at least two feet in its shorter dimension. Preferably, the top edge wall 12, side edge walls 13 and bottom edge wall 14 each have a relatively short dimension extending from the face wall 11 toward the side 20 of the recreational vehicle. For convenience, the relatively short dimension of top edge wall 12, side edge walls 13 and bottom edge wall 14 will be termed a “height,” regardless of the orientation of the cover 10. Preferably, the height of each of these is between approximately one inch and approximately eight inches, to minimize the external dimension of the recreation vehicle when the cover 10 is in the closed, or collapsed, condition. Although top edge wall 12 is depicted with a somewhat larger height that bottom edge wall 14, it is to be understood that top wall 12 may also have a somewhat smaller height than bottom wall 14, or an equal height.

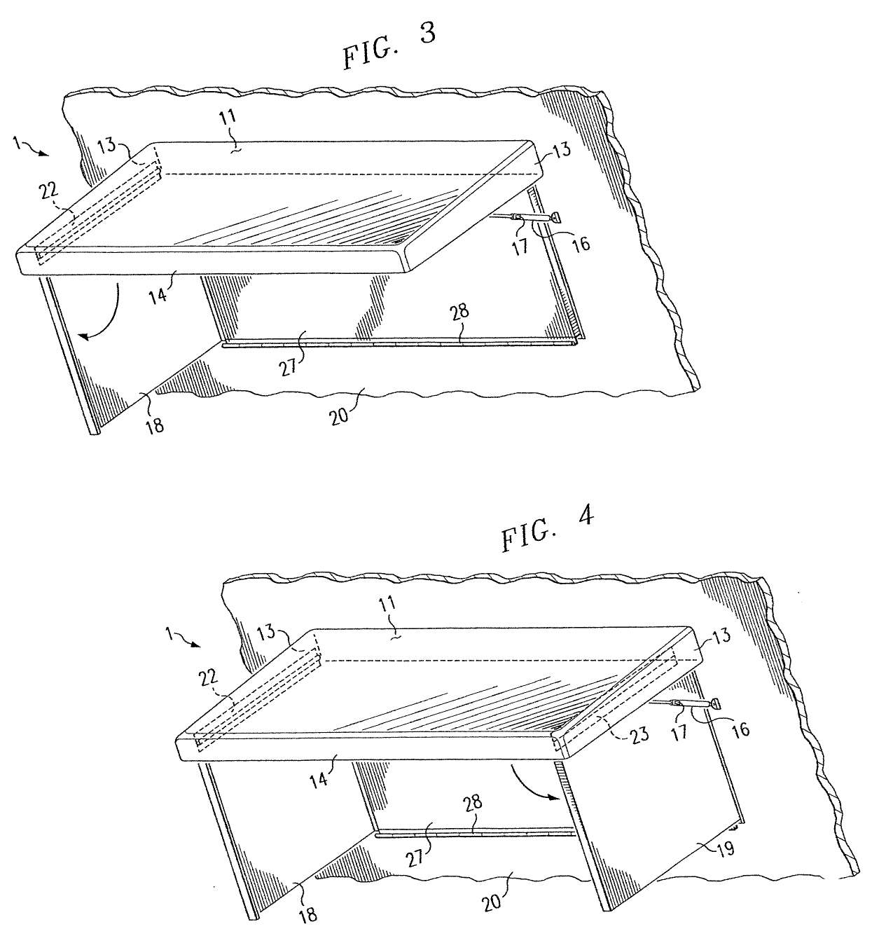

Top edge wall 12 includes horizontal hinge 15 for swingably securing the expandable cover 10 to the side 20 of the recreational vehicle, covering the aperture formed therein. Referring now to FIG. 2, expandable cover 10 is depicted in the open condition, after being swung open on hinge 15. Preferably, cover 10 also includes at least one support 16, which may conveniently be a telescoping, spring-loaded support. Support 16 may also have a lock mechanism 17 that locks into position in the extended condition depicted in FIG. 2, and can be unlocked to allow the cover 10 to swing closed when in the closed condition depicted in FIG. 1. However, a lock mechanism is not required.

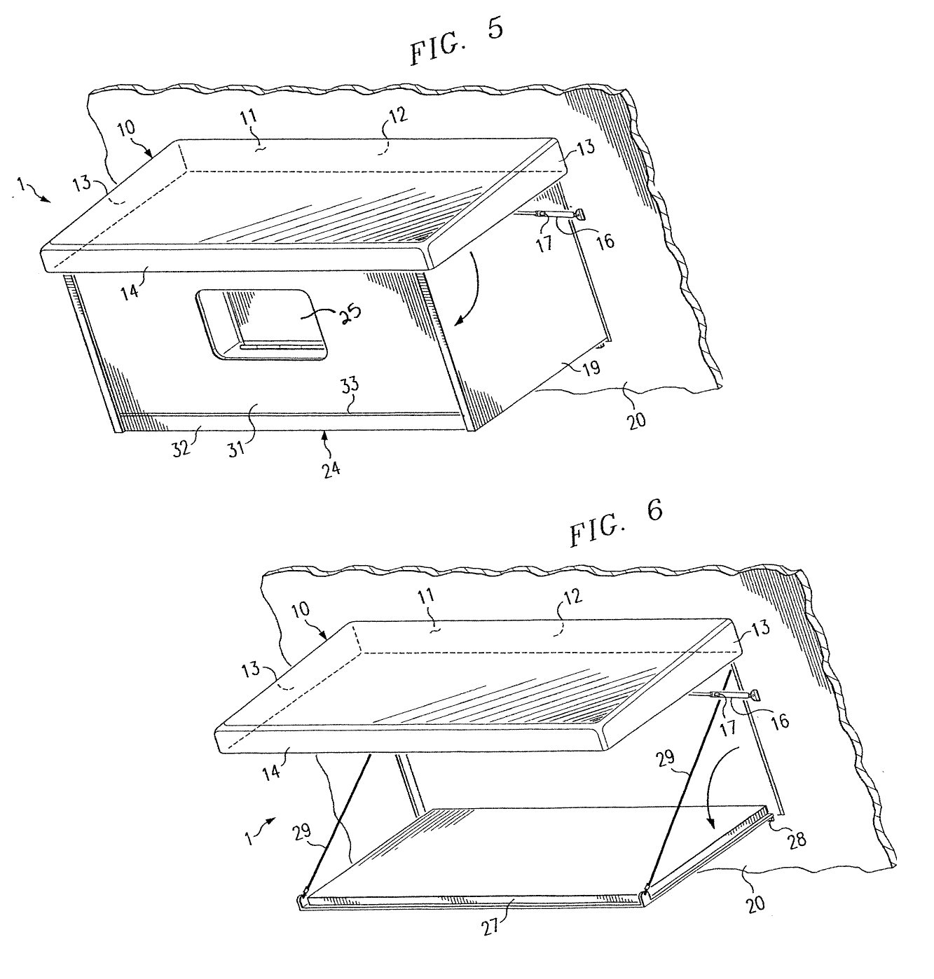

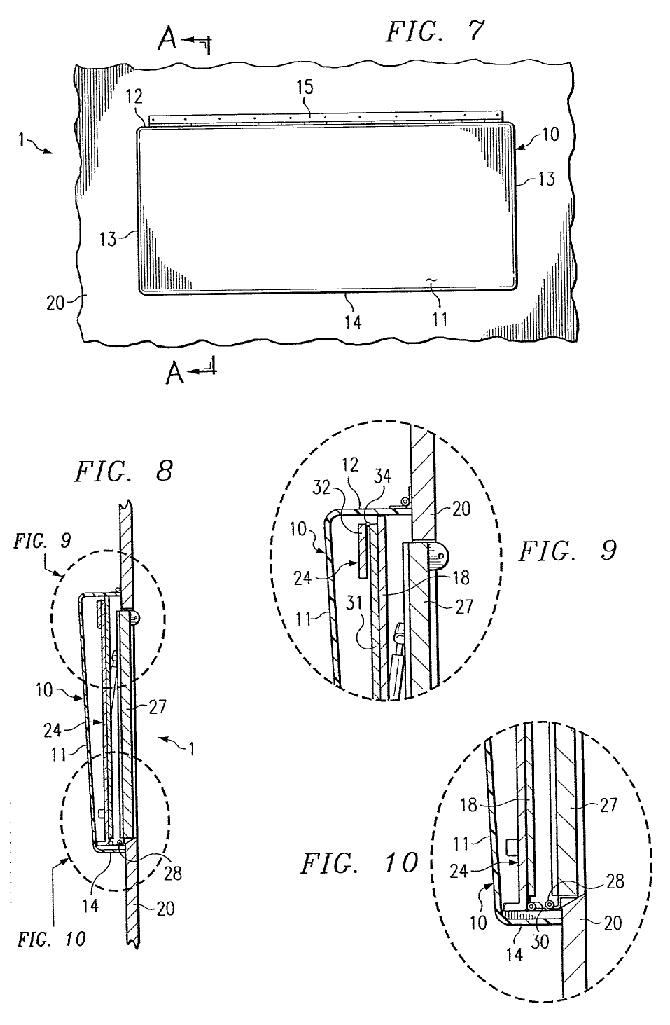

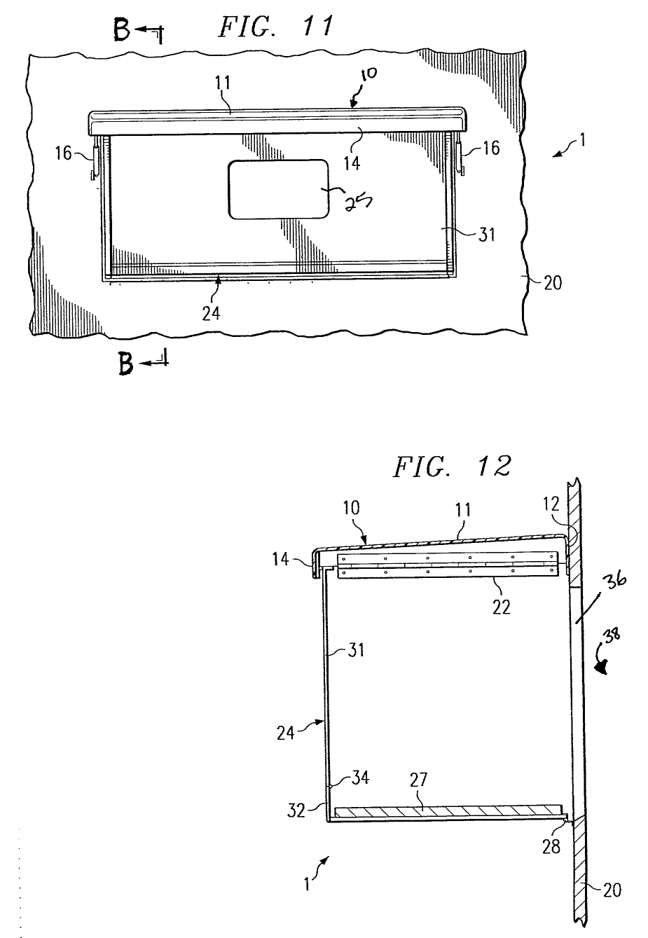

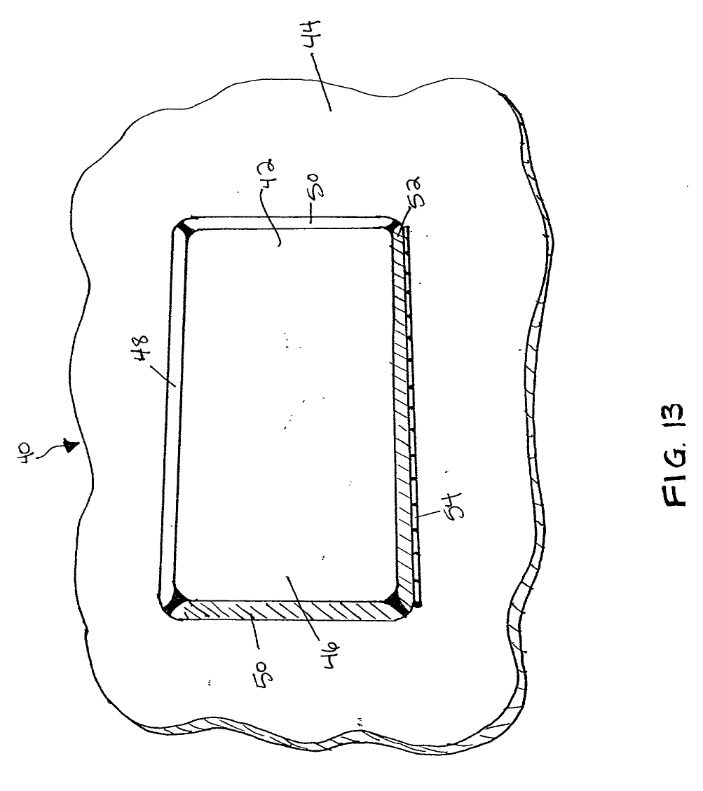

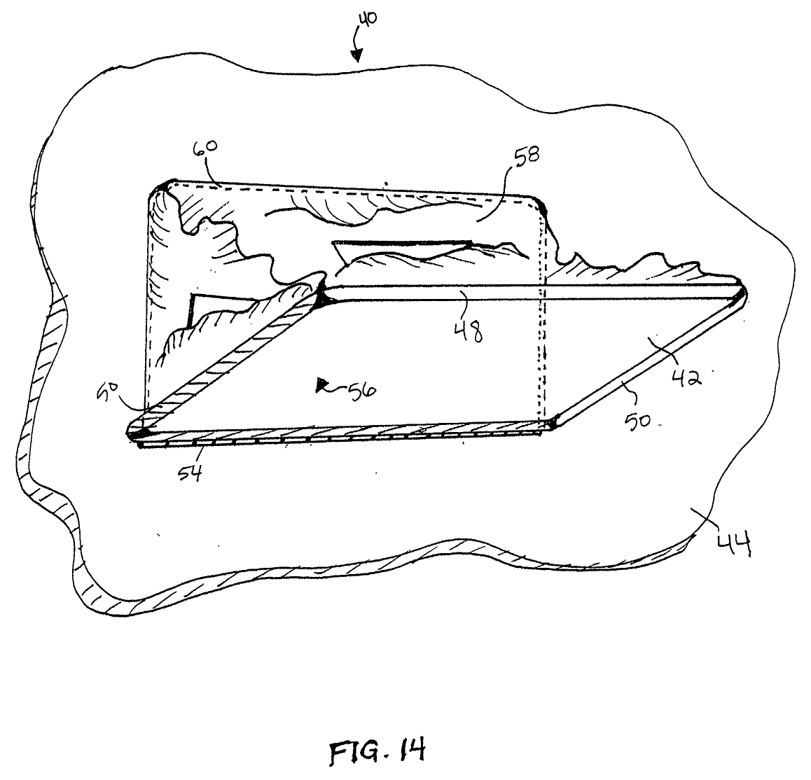

As depicted in FIGS. 3 and 4, after cover 10 is in the open condition, serving as a roof for the enclosure assembly, enclosure side walls 18 and 19, which are swingably attached to the inside of cover 10 by means of horizontal hinges 22 and 23, are swung open downwardly until they are generally vertical. Referring now to FIG. 5, enclosure face wall 24 is swingably attached to the inside portion cover 10, proximal to bottom wall 14, by horizontal hinge 30 (not visible in FIG. 5). Face wall 24 lowers down between enclosure side walls 18 and 19, and matably engages with the side walls to form durable temporary seams (e.g., by tongue and groove joint). Face wall 24 is conveniently formed in two parts, a large portion 31 and a smaller portion 32, with a seam 33 and hinge 34 (depicted in FIG. 9) between them. The hinge 34 allows portions 31 and 32 of front wall 24 to fold into themselves when the expandable enclosure assembly is in the closed position. Face wall 24 may have a window 25 for an occupant to view the outside and to transmit light or fresh air to the expandable enclosure assembly 1.

FIG. 6 depicts the design of the foldable support wall 27, with face wall 24 and side walls 18 and 19 omitted for clarity. After the side walls 18 and 19 and face wall 24 are opened, foldable support platform 27 is lowered from its approximately vertical stowed position on horizontal hinge 28 to an approximately horizontal position between side walls 18 and 19, and matably engages with the face and side walls to form durable temporary seams. Support platform 27 is secured by supports 29 (e.g., cables) at its sides, and may be used to support bedding (e.g., a mattress) or for some other desired purpose (e.g., storage). Face wall 24, side walls 18 and 19, and support 27 may be fabricated the same types of rigid material as cover 10 (e.g., mold-injected plastic, aluminum, carbon fiber, fiberglass, foam core laminate), although the exact composition of each does not have to be identical.

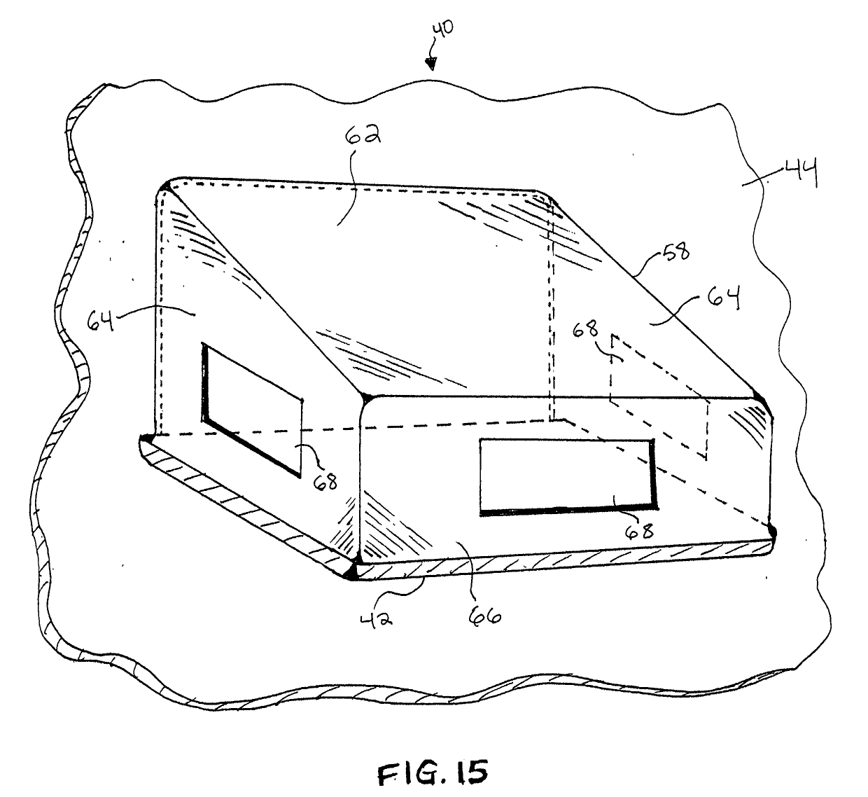

To close or stow the expandable cover 10 and platform 27, the foregoing steps are reversed. FIG. 7 is a front view depicting the expandable cover 10 in the closed or collapsed position. FIG. 8 is a sectional view taken along the line A-A of FIG. 7, depicting expandable cover 10, face wall 24, side wall 18 and platform 27 in the closed (or collapsed) position. While in the closed position, cover 10 and platform 27 may be securely latched in place by latches (not shown). FIG. 9 provides a detailed view of an upper portion of FIG. 8, while FIG. 10 provides a detailed view of a lower portion of FIG. 8.

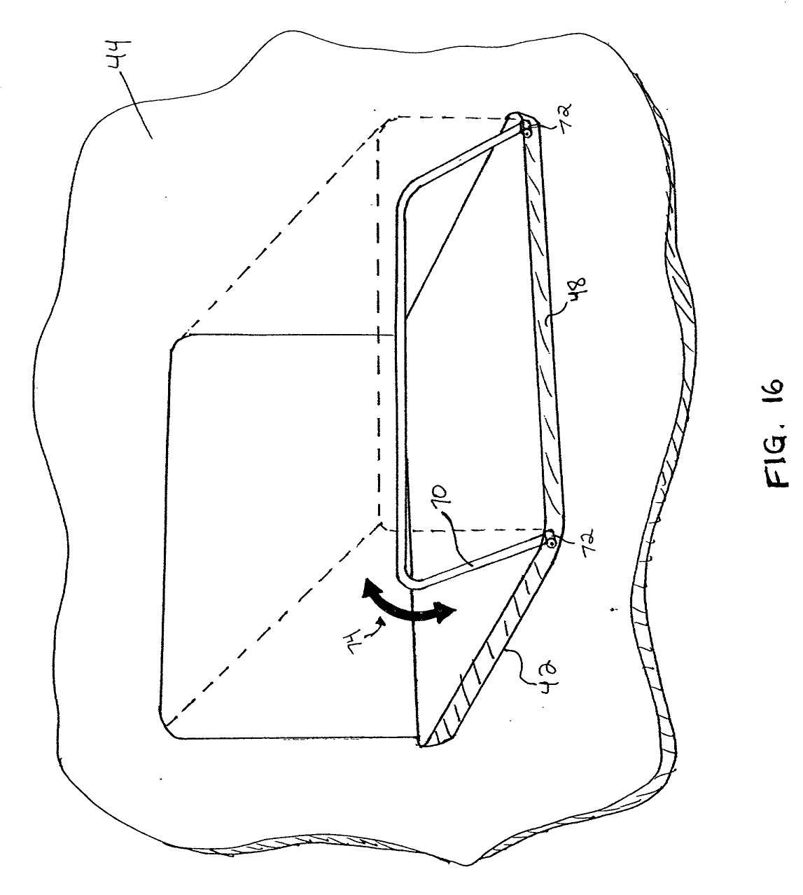

FIG. 11 provides a front view of enclosure 1 fully opened. Cover 10, held in place by supports 16, serves as a roof for enclosure 1. FIG. 12 is a sectional view taken along the line B-B of FIG. 11, providing a detailed depiction of enclosure 1 in the opened position. Platform 27 is lowered in place, securing face wall 24 and side walls 18 and 19 (not shown) into their respective open positions. Enclosure 1 is positioned relative to aperture 36, which is formed in the side 20 of the recreational vehicle, such that space within enclosure 1 is readily accessible from inside 38 the recreational vehicle.

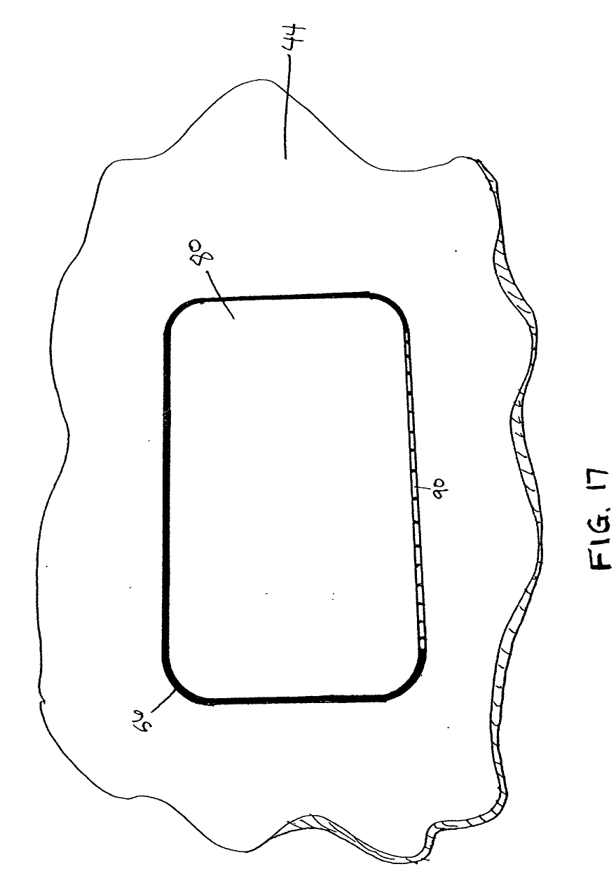

In another embodiment of the present invention, a supple assembly of a tent-like nature is configured to provide an expandable enclosure. Referring now to FIG. 13, an illustration of this embodiment is presented. Expandable enclosure assembly 40, having movable cover 42 attached to the side 44 of a recreational vehicle (not shown) is depicted. Cover 42 is shaped somewhat in the nature of a shallow box, with a face wall 46, a top edge wall 48, side edge walls 50 and a bottom edge wall 52. Cover 42 may be fabricated from mold-injected plastic, such as ABS, PVC or HDPE, for example. Cover 42 may also be fabricated from aluminum, carbon fiber, fiberglass, or a foam core laminate material. Foam core laminate or other insulated materials may be used to maintain a comfortable temperature within the expandable enclosure assembly 40 for an occupant. Preferably, cover 42 has relatively large dimensions consistent with use of the expanded space for a foldable bed, i.e., approximately six feet or greater in its longer dimension and at least two feet in its shorter dimension. Preferably, the top edge wall 48, side edge walls 50 and bottom edge wall 52 each have a relatively short dimension extending from the face wall 46 toward the side 44 of the recreational vehicle. For convenience, the relatively short dimension of top edge wall 48, side edge walls 50 and bottom edge wall 52 will be termed a “height,” regardless of the orientation of the cover 42. Preferably, the height of each of these is between approximately one inch and approximately eight inches, to minimize the external dimension of the recreation vehicle when the cover 42 is in the closed, or collapsed, condition. Top edge wall 48 may have a height that is somewhat larger, a somewhat smaller, or roughly equivalent to bottom edge wall 52.

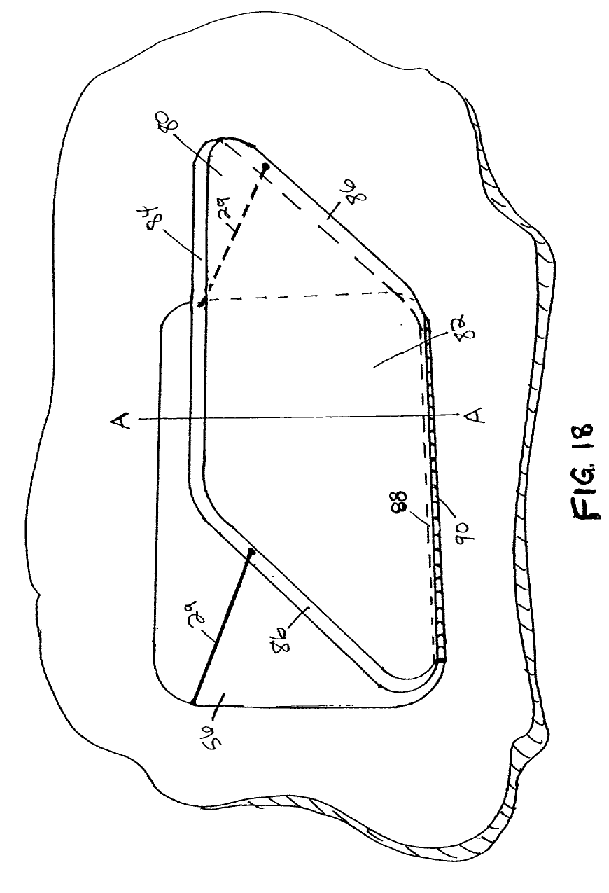

Bottom wall 52 includes horizontal hinge 54 for swingably securing the cover 42 to the side 44 of the recreational vehicle, over an aperture 56 (not shown) formed in side 44. Referring now to FIG. 14, cover 42 is depicted in a partially open position, after being swung open on hinge 54. A supple tent assembly 58 is coupled to, and disposed within, cover 42 such that as cover 42 is opened, assembly 58 deploys (i.e., opens) to provide a covered enclosure. Assembly 58 is fabricated from a sturdy, flexible, and waterproof material (e.g., nylon, treated canvas) that provides reliable shelter when deployed but is easily collapsed or folded for compact storage. Assembly 58 is securely attached to top wall 48 and side walls 50 of cover 42, as well as to perimeter 60 of aperture 56. Perimeter 60 comprises the side and upper portions of aperture 56, but does not include the portion of aperture 56 adjacent to hinge 54. Where assembly 58 couples to perimeter 60, an appropriate sealant is utilized to weatherproof enclosure 40. For example, a plastic or rubber gasket may be disposed along the seam between assembly 58 and perimeter 60. Alternatively, a waterproof resin or polymer composition may be applied thereto. Similarly, where assembly 58 couples to cover 42, an appropriate sealant is utilized to weatherproof enclosure 40.

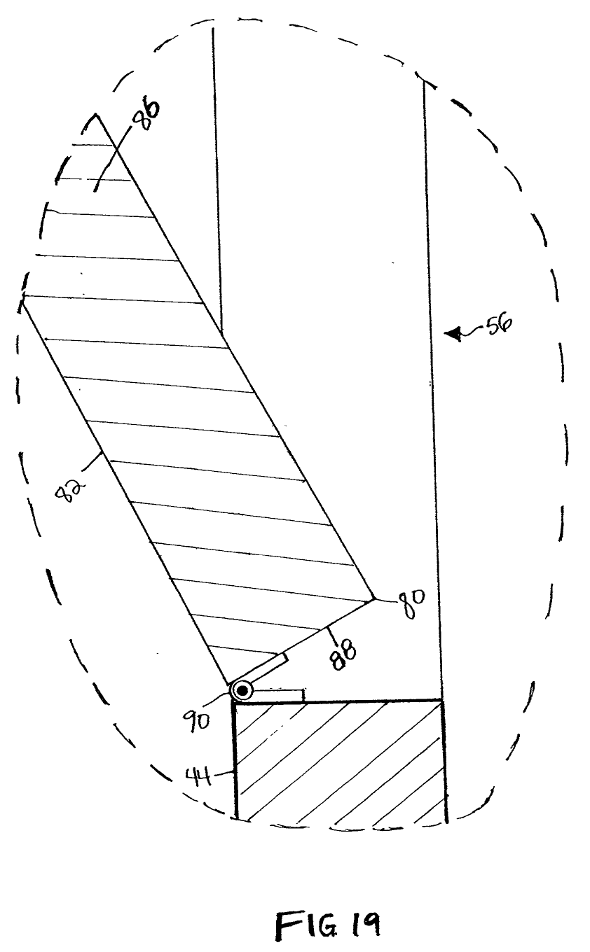

FIG. 15 depicts cover 42 in a fully deployed position. Cover 42 lowers from its approximately vertical stowed position on horizontal hinge 54 to an approximately horizontal open position. Once enclosure 40 is fully opened, cover 42 serves as a support platform for the enclosure and assembly 58, and may be used to support bedding (e.g., a mattress) or for some other desired purpose (e.g., storage). Depending upon the intended use for enclosure 40, and the composition of assembly 58, cover 42 may be secured in its horizontal position simply by the tension and strength of assembly 58. In one embodiment, cover 42 may be secured by supports 29 (e.g., cables) at its sides (not shown in FIG. 15). Optionally, hinge 54 may be formed to limit the opening of cover 42 to a horizontal position, and provide extra support therefore. Further optionally, support members (not shown), such as braces or struts, may be permanently or removably attached to the outside of face wall 46 for deployment between cover 42 and side 44 (or the ground), providing even further support for cover 42 in its horizontal position.

Depending upon the shape of aperture 56 and the desired aesthetics of enclosure 40, assembly 58 may, itself, take a number of shapes (e.g., semi-spherical, semi-conical). As depicted in FIG. 15, assembly 58 is of a polygonal shape, having an upper wall 62, two side walls 64, and a front wall 66. Front wall 66, and side walls 64, or any combination thereof, may have one or more windows 68 for an occupant to view the outside and to transmit light or fresh air to the enclosure assembly 40.

Referring now to FIG. 16, enclosure 40 also comprises tent support assembly 70. Assembly 70 is provided to fully expand, and provide interior support for, assembly 58. As depicted in FIG. 16, assembly 70 comprises a movable U-shaped frame member, coupled at each of its open ends to cover 42, near top edge wall 48, by hinge members 72. Assembly 70 may comprise any lightweight durable material, such as hollow plastic or metal tubing, that provides sufficient support for tent assembly 58 while in use. In its closed position, assembly 70 stows flat inside of cover 42. Assembly 70 is formed to match the profile of front tent wall 66 such that, when rotational opening force 74 is manually applied, assembly 70 is raised to a substantially vertical position, fully engaging front wall 66, expanding tent assembly 58 to its fullest form, and providing support for all of the constituent members thereof. Hinge members 72 may be provided with a locking or ratcheting mechanism to constrain the movement of, and provide support to, assembly 70.

Optionally, assembly may comprise additional frame members disposed, in parallel, along the length of cover 42 to provide additional lateral and vertical support internal to tent assembly 58. Assembly 70 may, alternatively, comprise one or more external frame members removably coupled to the exterior of assembly 58. Alternatively, assembly 70 may comprise one or more deformable support members permanently attached to, or within, assembly 58 that provide desired shape and support when enclosure 40 is opened, readily collapse or fold to store within cover 42 when enclosure 40 is closed. Other combinations and contrivances, providing the necessary shaping, support, and storage functionalities, are contemplated by the present invention.

Referring now to FIG. 17, an alternative embodiment of a movable cover 80 for expandable enclosure assembly 40 is illustrated. Cover 80 is formed of size and shape substantially identical to that of the inner perimeter of aperture 56. Cover 80 is, however, nominally smaller, such that cover 80 may, in its closed position, fit snuggle within aperture 56 while allowing just enough room for attachment and weatherproofing materials. In its closed position, an outer face wall 82 of cover 80 aligns flush with the outer side 44 of the vehicle, sealing aperture 56 in weatherproof manner.

As depicted in FIG. 18, cover 80 is shaped somewhat in the nature of a shallow box, with face wall 82, a top edge wall 84, side edge walls 86 and a bottom edge wall 88. Cover 80 may be fabricated from mold-injected plastic, such as ABS, PVC or HDPE, for example. Cover 80 may also be fabricated from aluminum, carbon fiber, fiberglass, or a foam core laminate material. Foam core laminate or other insulated materials may be used to maintain a comfortable temperature within the expandable enclosure assembly 40 for an occupant. Preferably, cover 80 has relatively large dimensions consistent with use of the expanded space for a foldable bed, i.e., approximately six feet or greater in its longer dimension and at least two feet in its shorter dimension. Preferably, walls 84, 86, and 88 each have a relatively short dimension extending, in the closed position, inwardly from face wall 82 toward the inside of the recreational vehicle. For convenience, the relatively short dimension of walls 84, 86, and 88 will be termed a “height,” regardless of the orientation of the cover 80. Preferably, the height of each of these is between approximately one inch and approximately eight inches, depending upon the thickness of the side wall of the recreational vehicle.

Bottom wall 88 incorporates horizontal hinge 90 for swingably securing the cover 80 within the recess of aperture 56. This is shown in greater detail with reference now to FIG. 19, which depicts a cross sectional view taken along line A-A of FIG. 18. As shown, hinge 90 is disposed upon a lower surface 92 of aperture 56, within aperture 56, adjacent to the outer side 44 of the vehicle's side wall. Hinge 90 couples the bottom wall 88 of cover 80 to surface 92 within aperture 56. Hinge 90 is configured such that cover 80 is swingably closable, coming to rest at a closed position within aperture 56. Depending upon the relative sizes and dimensions of all the related apparatus, and upon the particular weatherproofing devices, if any, that are utilized, hinge 90 may be a thin form-factor hinge mounted externally to cover 80 and surface 92. Alternatively, hinge 90 may be coupled to cover 80 or surface 92 within a recessed area formed therein, to allow for a flush engagement of bottom wall 88 with surface 92.

Referring back to FIG. 18, cover 80 is depicted in a partially open position, after being swung open on hinge 90. Supple tent assembly 58 (not shown) is coupled to, and disposed within, cover 80 such that as cover 80 is opened, assembly 58 opens to provide a covered enclosure. Cover 80 lowers from its approximately vertical stowed position on horizontal hinge 90 to an approximately horizontal open position. Once enclosure 40 is fully opened, cover 80 serves as a support platform for the enclosure and assembly 58, and may be used to support bedding (e.g., a mattress) or for some other desired purpose (e.g., storage). Depending upon the intended use for enclosure 40, and the composition of assembly 58, cover 80 may be secured in its horizontal position simply by the tension and strength of assembly 58. In an alternative embodiment, cover 80 may be secured by supports 29 (e.g., cables), couple between side walls 86 and aperture 56.

Optionally, hinge 90 may be formed to limit the opening of cover 80 to a horizontal position, and provide extra support therefore. Further optionally, support members (not shown), such as braces or struts, may be permanently or removably attached to the outside of face wall 82 for deployment between cover 80 and side 44 (or the ground), providing even further support for cover 80 in its horizontal position.

In all the embodiments described above, additional weatherproofing elements may be added to portions of the enclosure to improve the overall integrity of the enclosure, especially when closed. For example, a narrow, waterproof gasket may be disposed around the perimeter of cover 80. Similarly, weather-stripping may be disposed along the seams of enclosure 1 to improve the thermal stability inside the enclosure.

While this invention has been described with reference to illustrative embodiments, this description is not intended to be construed in a limiting sense. Upon reference to the description, it will be apparent to persons skilled in the art that various modifications and combinations of the illustrative embodiments as well as other embodiments of the invention can be made without departing from the spirit and scope of the invention. It is therefore intended that the appended claims encompass any such modifications or embodiments.

What is claimed is:

1. An externally expandable enclosure, operatively associated with an aperture formed in a recreational vehicle wall, comprising:
a cover, having a plurality of sidewalls, a face wall, and a hinge assembly coupling the cover to the vehicle wall in relation to the aperture such that the cover, when in a closed position, seals the aperture; and
an enclosure assembly, coupled to the cover, adapted to collapse and stow in the aperture within the space bounded by the face wall and sidewalls when the cover is closed, and adapted to provide an enclosed space accessible through the aperture when the cover is opened.

2. The expandable enclosure of claim 1, wherein the enclosure assembly comprises a supple assembly.

3. The expandable enclosure of claim 1, wherein the enclosure assembly comprises a rigid assembly.

4. The expandable enclosure of claim 2, wherein the enclosure assembly comprises a tent assembly and the cover is adapted to provide a bottom support platform for the tent assembly.

5. The expandable enclosure of claim 3, wherein the cover is adapted to provide a roof for the enclosure assembly and the enclosure assembly comprises:
a plurality of wall members foldably coupled to the cover; and
a bottom support platform foldably coupled to the recreational vehicle wall and adapted to securely engage with the wall members when opened.

6. The expandable enclosure of claim 4, further comprising a support member for holding the cover in an open position.

7. The expandable enclosure of claim 6, wherein the support member is lockable.

8. The expandable enclosure of claim 5, further comprising a support member for holding the cover in an open position.

9. The expandable enclosure of claim 8, wherein the support member is lockable.

10. The expandable enclosure of claim 8, wherein the support member is a cable.

11. The expandable enclosure of claim 4, further comprising a tent support assembly adapted to expand and provide support for the tent assembly.

12. The expandable enclosure of claim 12, wherein the tent support assembly comprises one or more substantially U-shaped members rotatably coupled to the cover inside the tent assembly.

13. The expandable enclosure of claim 4, wherein the tent assembly comprises a window.

14. The expandable enclosure of claim 5, wherein one or more of the wall members comprises a window.

15. A method of providing an expandable enclosure for a recreational vehicle comprising the steps of:
forming an aperture in a wall of the recreational vehicle;
providing a movable cover, having a face wall and a plurality of edge walls, coupled to the recreational vehicle proximal to the aperture such that the cover is movable between a generally vertical closed position sealing the aperture and a generally horizontal open position beneath the aperture;
providing a collapsible tent assembly coupled to the cover and to the aperture such that, as the cover is moved from the closed to the open position, the tent assembly opens to provide a covered enclosure, and such that the tent assembly collapses to within the aperture when the cover is closed; and
providing a tent support assembly coupled to the cover and operable to fully expand, and provide support to, the tent assembly.

16. A method of providing an expandable enclosure for a recreational vehicle comprising the steps of:
forming an aperture in a wall of the recreational vehicle;
providing a movable cover, having a face wall and a plurality of edge walls, hinged to the recreational vehicle proximal to the aperture such that the cover is movable between a generally vertical closed position covering the aperture and a generally horizontal open position above the aperture;
providing a plurality of side walls, hinged to an inner surface of the cover and adapted to open downwardly and matably engage with one another when the cover is moved from the closed to the open position, and adapted to fold and stow between the cover and the exterior surface of the recreational vehicle within the cover when the cover is closed; and
a support platform, hinged to the recreational vehicle beneath the aperture and adapted to move between a closed position, between the cover and the exterior surface of the recreational vehicle when the cover is closed, and an open, generally horizontal position in which the platform matably engages with the side walls.

17. The method of claim 16, wherein the step of providing a plurality of side walls further comprises providing a window in one of the side walls.

18. The method of claim 16, wherein the steps of providing the movable cover, the support platform, and the side walls comprise fabricating each from mold-injected plastic.

19. The method of claim 16, wherein the steps of providing the movable cover, the support platform, and the side walls comprise fabricating each from aluminum.

20. The method of claim 16, wherein the steps of providing the movable cover, the support platform, and the side walls comprise fabricating each from foam core laminate.

21. An expandable enclosure apparatus for a recreational vehicle comprising:
an aperture formed in a wall of the recreational vehicle;
a hinge coupled to a lower surface of the aperture; and
a movable cover, having a face wall and a plurality of edge walls, coupled to the hinge such that the cover is movable between a generally vertical closed position, in which the movable cover fits within the aperture and an outer surface of the face wall is flush with an outer surface of the wall of the recreational vehicle, and a generally horizontal open position beneath the aperture.
